(19) United States
(12) Patent Application Publication
(10) Pub. No.: US 2017/0370459 A1
(43) Pub. Date: Dec. 28, 2017

(54) POWER TRANSMISSION DEVICE

(71) Applicant: SEJIN-IGB CO., LTD., Asan-si, Chungcheongnam-do (KR)

(72) Inventor: Sun Ho LIM, Asan-si, Chungcheongnam-do (KR)

(21) Appl. No.: 15/548,093

(22) PCT Filed: Nov. 13, 2015
(86) PCT No.: PCT/KR2015/012198

§ 371 Date: Aug. 1, 2017

(30) Foreign Application Priority Data
Feb. 2, 2015 (KR) 10-2015-0015889

(51) Int. Cl. F16H 55/10; F16H 55/26; F16H 19/04; F16H 57/04; F16H 1/10

(52) U.S. Cl. CPC F16H 55/10; F16H 57/0431; F16H 1/10; F16H 19/04; F16H 55/26

(57) ABSTRACT

A power transmission device includes a plurality of power transfer pins mutually corresponding to a tooth shape formed on an outer gear to move the outer gear and having an arrangement structure of a circular shape; a pin rotation support portion connected to the plurality of power transfer pins and rotatably supporting the plurality of power transfer pins; and an external rotor motor portion arranged inside in a radial direction of the pin rotation support portion and connected to the pin rotation support portion, and generating rotational power to rotate the pin rotation support portion arranged outside.

### TECHNICAL FIELD

The present inventive concept relates to a power transmission device, and more particularly, to a power transmission device which may be easily applied with no restriction to semiconductor or flat display equipment requiring compact parts because not only the overall height of a device, but also an exterior size thereof may be remarkably reduced.

### BACKGROUND ART

Power transmission devices are a series of devices implementing a linear motion, a curved motion, a circular motion, etc. of a device by using rotational power of a motor.

The power transmission devices have been widely used for various industrial machines including semiconductor equipment, flat display equipment for LCDs, PDPs, OLEDs, etc. Such power transmission devices have been already filed by and registered to the present applicant.

FIG. 1 is a side view illustrating a configuration of a power transmission device according to the related art in a use state.

Referring to FIG. 1, the power transmission device 1 according to the related art may be partially coupled to a slider 3, for example, to allow the slider 3 coupled to a base plate 2 in a structure of a rail 4 to have a linear motion.

For the linear motion of the slider 3 with respect to the base plate 2, the power transmission device 1 connected to the slider 3 may include a pinion 6 or a pin gear that is engaged with a rack 5 fixed to an area of the base plate 2. A separate motor 8 is provided outside the pinion 6 and connected to the pin gear 6.

The pinion 6 is coupled to an end portion of a shaft 7 extending outwardly from the power transmission device 1 and engaged with the rack 5 during the assembly of the device of FIG. 1.

In the above structure, when a motor 8 is driven, the shaft 7 is rotated based on interactions of built-in parts of the power transmission device 1 and thus the pinion 6 is rotated.

As the pinion 6 is engaged with the rack 5 that is positionally fixed, the pinion 6 is consequently rotated, performing a linear motion along a lengthwise direction of the rack 5, and thus the linear motion of the slider 3 with respect to the base plate 2 may be implemented.

Accordingly, when a desired part or apparatus is mounted on the slider 3, the part or apparatus may perform a linear motion.

The structure of the power transmission device 1 of FIG. 1 is one of the most used shapes at sites. Since the motor 8 is directly coupled to a rotation shaft of the pinion 6 with a decelerator 9, the overall height H1 of the power transmission device 1 may be increased.

When the overall height H1 of the power transmission device 1 is increased as in the related art, the power transmission device 1 becomes huge in size accordingly and thus there may be some restrictions in the application of the power transmission device 1 to compact equipment such as an INDEX that is widely used for semiconductor or flat display equipment. In this regard, there is a demand for complementation for the structure of a power transmission device.

### DETAILED DESCRIPTION OF THE INVENTIVE CONCEPT

### Technical Problem

The present inventive concept provides a power transmission device which may be easily applied with no restriction to semiconductor or flat display equipment requiring compact parts because not only the overall height of a device, but also an exterior size thereof may be remarkably reduced.

### Advantageous Effects

According to the present inventive concept, since not only the overall height of a device, but also an exterior size thereof may be remarkably reduced, the power transmission device may be easily applied with no restriction to semiconductor or flat display equipment requiring compact parts.

### DESCRIPTION OF THE DRAWINGS

FIG. 1 is a side view illustrating a configuration of a power transmission device according to the related art in a use state.

FIG. 2 is a power transmission device according to an embodiment of the present inventive concept.

FIG. 3 is a schematic structural view of the power transmission device of FIG. 2.

FIG. 4 is an exploded perspective view of a power transfer pin and a pin rotation support portion.

FIG. 5 is a cross-sectional view taken along a line A-A of FIG. 3.

FIG. 6 is an enlarged view of an external rotor motor portion of FIG. 5.

FIG. 7 illustrates a modified example of the power transfer pin.

### BEST MODE

According to an aspect of the present inventive concept, a power transmission device includes a plurality of power transfer pins mutually corresponding to a tooth shape formed on an outer gear to move the outer gear and having an arrangement structure of a circular shape; a pin rotation support portion connected to the plurality of power transfer pins and rotatably supporting the plurality of power transfer pins; and an external rotor motor portion arranged inside in a radial direction of the pin rotation support portion and connected to the pin rotation support portion, and generating rotational power to rotate the pin rotation support portion arranged outside.

The external rotor motor portion may include a rotor connected to the pin rotation support portion inside in the radial direction of the pin rotation support portion and rotating with the pin rotation support portion; and a stator fixedly arranged inside a radial direction of the rotor and rotating the rotor by an applied current.

The pin rotation support portion may rotatably support the power transfer pin and including a rotor connection body forming one body with the rotor.

The rotor connection body may be provided in a pair, each rotor connection body arranged at each of opposite end portions of the power transfer pins and connected to the plurality of power transfer pins.

The pin rotation support portion may further include a plurality of pin support bearings arranged at many as the number of the plurality of power transfer pins at equiangular intervals along a circumferential direction of the rotor connection body, and supporting a rotation motion of the plurality of power transfer pins.

The pin rotation support portion may further include a plurality of oil seals provided corresponding to the plurality of pin support bearings one by one and seals a pin insertion support hole in the rotor connection body in which the plurality of power transfer pins are inserted and supported.

The external rotor motor portion may further include a fixed shaft arranged inside the stator.

The power transmission device may further include an absolute position sensor coupled to an end portion of the fixed shaft and detecting absolute positions of the plurality of power transfer pins.

The power transmission device may further include a closing cap coupled to a periphery of the external rotor motor portion and protecting the external rotor motor portion.

The power transmission device may further include a heat sink arranged around the plurality of power transfer pins and radiating heat generated from the external rotor motor portion.

The power transmission device may further include a control circuit provided in the heat sink.

An air flow space portion for air flow may be formed between the external rotor motor portion and the control circuit in the heat sink.

The outer gear may be one of a rack, an external gear, and an internal gear.

### MODE OF THE INVENTIVE CONCEPT

The attached drawings for illustrating preferred embodiments of the present inventive concept are referred to in order to gain a sufficient understanding of the present inventive concept, the merits thereof, and the objectives accomplished by the implementation of the present inventive concept.

Hereinafter, the present inventive concept will be described in detail by explaining preferred embodiments of the inventive concept with reference to the attached drawings. Like reference numerals in the drawings denote like elements.

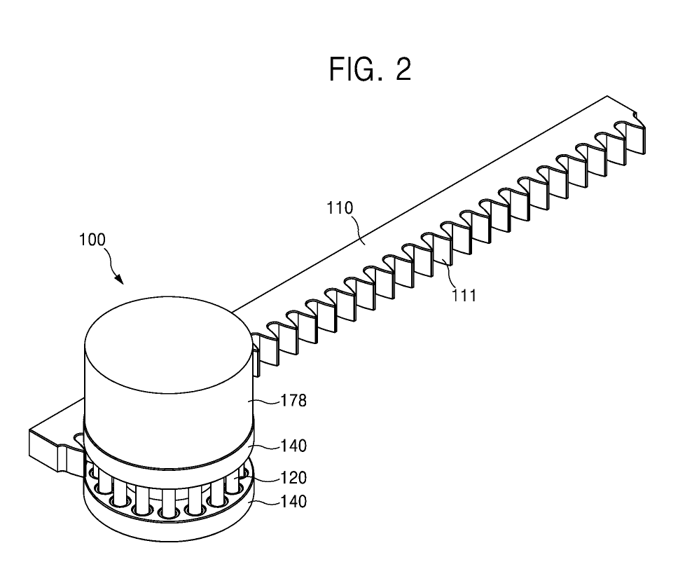

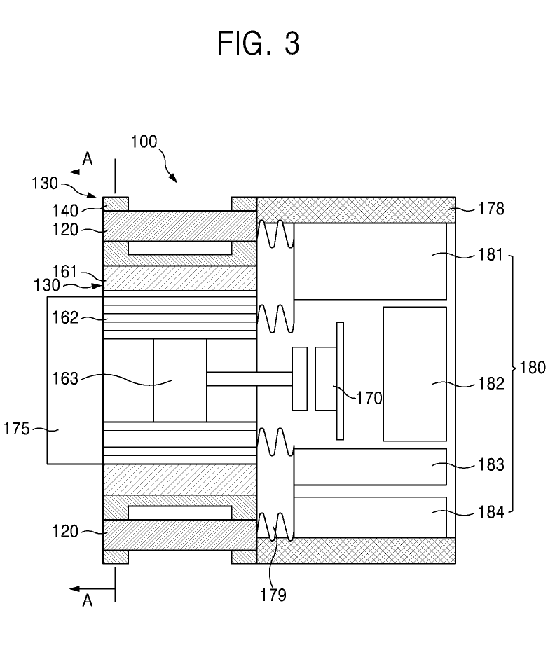

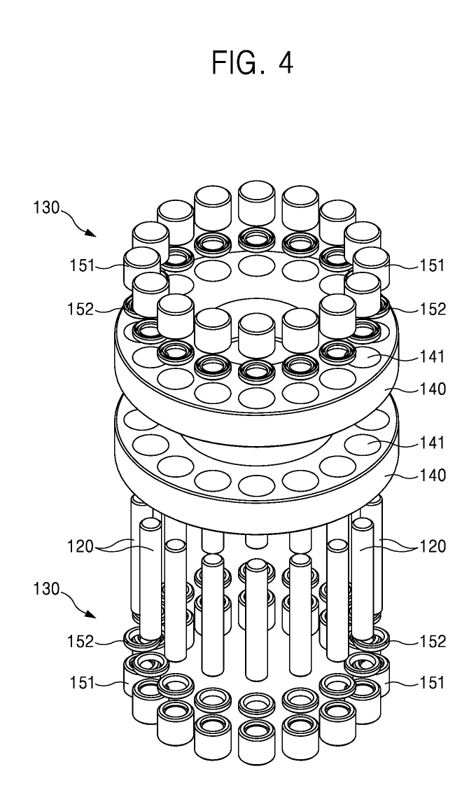

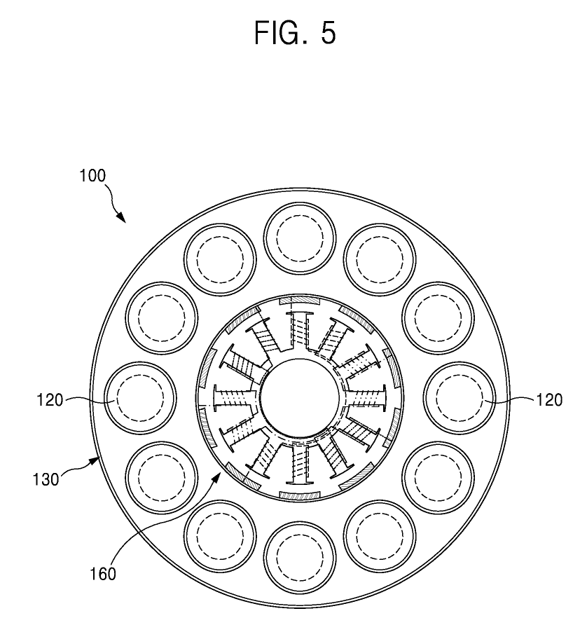

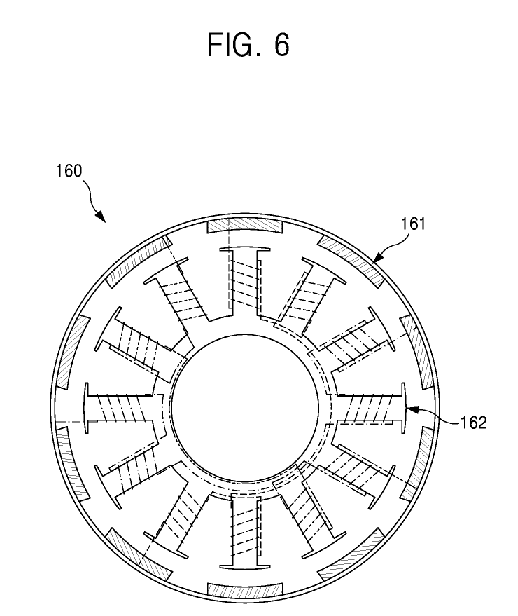

FIG. 2 is a power transmission device according to an embodiment of the present inventive concept. FIG. 3 is a schematic structural view of the power transmission device of FIG. 2. FIG. 4 is an exploded perspective view of a power transfer pin and a pin rotation support portion. FIG. 5 is a cross-sectional view taken along a line A-A of FIG. 3. FIG. 6 is an enlarged view of an external rotor motor portion of FIG. 5.

Referring to these drawings, a power transmission device according to the present embodiment may be easily applied with no restriction to semiconductor or flat display equipment requiring compact parts because not only the overall height of a device, but also an exterior size thereof may be remarkably reduced. The power transmission device may include a plurality of power transfer pins 120 having an arrangement structure of a circular shape and moving a rack 110 as an output gear mutually engaged via a rack tooth shape 111 formed in the rack 110, a pin rotation support portion 130 rotatably supporting the power transfer pins 120, and an external rotor motor portion 160 arranged inside in a radial direction of the pin rotation support portion 130 and generating rotational power to rotate the pin rotation support portion 130.

For reference, although the rack 110 is disclosed as an outer gear in the present embodiment, the outer gear may be an external gear or an internal gear having a circular shape.

For example, when the outer gear is the rack 110 as illustrated in FIG. 2, the rack 110 may perform a linear motion as the power transmission device 100 according to the present embodiment is driven.

In contrast, when the outer gear is an external gear or an internal gear, the external gear or the internal gear may perform a rotational motion as the power transmission device 100 according to the present embodiment is driven.

A rack tooth shape 111 is formed at one side of the rack 110. The rack tooth shape 111 is continuously and uniformly formed at one side of the rack 110 along a lengthwise direction of the rack 110.

The rack tooth shape 111 formed on the rack 110 may be any one of a trochoid tooth shape, a cycloid tooth shape, and an involute tooth shape.

As such, the power transfer pins 120 are provided such that the rack 110 may perform a linear motion. In the present embodiment, the power transfer pins 120, as a power source for moving the rack 110, performs a rotational motion in place corresponding to the rack tooth shape 111 of the rack 110. The power transfer pins 120 may have an arrangement structure of a circular shape.

Next, as illustrated in detail in FIG. 4, the pin rotation support portion 130, as a structure connected to the power transfer pins 120 having an arrangement structure of a circular shape, rotatably support the power transfer pins 120.

The pin rotation support portion 130 may include a rotor connection body 140, a pin support bearing 151, and an oil seal 152.

The rotor connection body 140 is a structure rotatably supporting the power transfer pins 120 and forming one body with a rotor 161.

The rotor connection body 140 is arranged in a pair at opposite end portions of the power transfer pins 120 and connected to the power transfer pins 120.

In other words, the rotor connection body 140 is arranged in a pair spaced apart in parallel from each other by a length of the power transfer pins 120 or less. The pair of rotor connection bodies 140 are connected to the opposite end portions of the power transfer pins 120 and rotatably supporting the power transfer pins 120.

A plurality of pin insertion support holes 141, in which the power transfer pins 120 are inserted and supported, are provided in the rotor connection body 140 at equiangular intervals along a circumferential direction.

The pin support bearing 151 is arranged as many as the number of the power transfer pins 120 at the equiangular intervals along the circumferential direction of the rotor connection body 140, and support a rotation motion of the power transfer pins 120.

The pin support bearing 151 may employ various rolling bearings having superior rigidity including a ball bearing.

The oil seal 152 is provided corresponding to the pin support bearing 151 one by one and seals the pin insertion support hole 141 in the rotor connection body 140 in which the power transfer pins 120 are inserted and supported.

In the present embodiment, since the rotor connection body 140 is provided in a pair, the pin support bearing 151 and the oil seal 152 are applied to each of the pair of the rotor connection bodies 140.

In other words, the rotor connection body 140, the pin support bearing 151, and the oil seal 152 may form a symmetric structure with respect to the power transfer pins 120. Accordingly, an assembly work may be easy.

The external rotor motor portion 160 is arranged inside in the radial direction of arranged inside in the radial direction of the pin rotation support portion 130 and connected to the pin rotation support portion 130, and generates rotational power to rotate the pin rotation support portion 130 arranged outside the external rotor motor portion 160.

In other words, in the power transmission device 100 of the present embodiment, while the external rotor motor portion 160 is arranged inside the pin rotation support portion 130, the external rotor motor portion 160 rotates the pin rotation support portion 130 and the power transfer pins 120 that are structures arranged outside the external rotor motor portion 160.

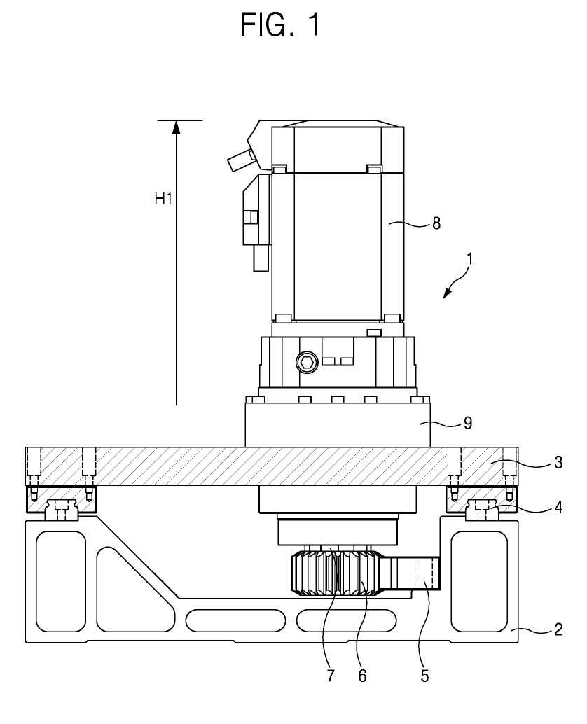

In this case, not only a complicated structure of directly connecting the separate motor 8 as illustrated in FIG. 1 is not needed, but also the overall height of a device as well as the exterior size thereof may be remarkably reduced and thus the power transmission device may be easily applied to semiconductor or flat display equipment requiring compact parts, in particular to compact equipment such as an INDEX.

The external rotor motor portion 160 is connected to the pin rotation support portion 130 inside in the radial direction of the pin rotation support portion 130, and may include the rotor 161 rotated with the pin rotation support portion 130 and a stator 162 fixedly arranged inside in a radial direction of the rotor 161 and rotating the rotor 161 by an applied current.

The rotor 161 is provided as a magnet, and the stator 162 is provided as a coil structure with an electric line wound therearound.

Accordingly, as illustrated in FIG. 6, when current is applied to the stator 162, a magnetic force is generated according to the Fleming's law. By alternately changing the polarity of current, the rotor 161 that is a magnet is rotated according to the polarity of induced magnetism.

Since the rotor connection body 140 is coupled to the rotor 161, as the rotor 161 rotates, the rotor connection body 140 rotates together and thus the power transfer pins 120 may be induced to be rotated.

A fixed shaft 163 is provided inside the stator 162. Unlike the rotor 161 that is rotatable, the fixed shaft 163 is fixed without being rotated.

Accordingly, the fixed shaft 163 may be provided with a sensor such as an absolute position sensor 170. In the present embodiment, the absolute position sensor 170 is coupled to an end of the fixed shaft 163 and senses absolute positions of the power transfer pins 120. For example, the absolute positions are misaligned, a control of, for example, forcibly stopping the motion of the external rotor motor portion 160 may be performed.

A closing cap 175 for protecting the external rotor motor portion 160 is provided around the external rotor motor portion 160. The closing cap 175 may protect the external rotor motor portion 160. When the closing cap 175 is open, a path for maintenance and repair of the external rotor motor portion 160 may be formed.

A heat sink 178 for radiating heat generated from the external rotor motor portion 160 is provided around the power transfer pins 120 at an opposite side of the closing cap 175.

The heat sink 178 may have a housing structure in which various control circuits 180 for controlling the power transmission device 100 according to the present embodiment are provided.

The control circuits 180 may include a power circuit 181, a wireless communication circuit 182, an MCU circuit 183, and an external rotor motor portion drive circuit 184.

In the present embodiment, the power circuit 181, the wireless communication circuit 182, the MCU circuit 183, and the external rotor motor portion drive circuit 184 are all illustrated to be included, but some of them may be excluded in the application.

An air flow space portion 179 for air flow is formed in the heat sink 178 between the external rotor motor portion 160 and the control circuits 180. The air flow space portion 179 may prevent a phenomenon that the heat generated from the external rotor motor portion 160 is directly transferred to the control circuits 180 and thus the control circuits 180 is damaged.

The operation of the power transmission device 100 configured as above is described below.

Current is applied to the stator 162 when the power transmission device 100 is assembled as illustrated in FIG. 2, that is, to the rack 110.

When current is applied to the stator 162, a magnetic force is generated according to the Fleming's law. By alternately changing the polarity of current, the rotor 161 that is a magnet is rotated according to the polarity of induced magnetism.

Since the rotor connection body 140 is coupled to the rotor 161, as the rotor 161 rotates, the rotor connection body 140 rotates together and thus the power transfer pins 120 may be induced to be rotated.

Accordingly, as the power transfer pins 120 rotate, each of the power transfer pins 120 is engaged with the rack tooth shape 111 of the rack 110 performing interaction therebetween, and thus the rack 110 may perform a linear motion.

According to the power transmission device 100 of the present embodiment having the above structure and operation, since not only the overall height of a device, but also an exterior size thereof may be remarkably reduced, the power transmission device 100 may be easily applied with no restriction to semiconductor or flat display equipment requiring compact parts.

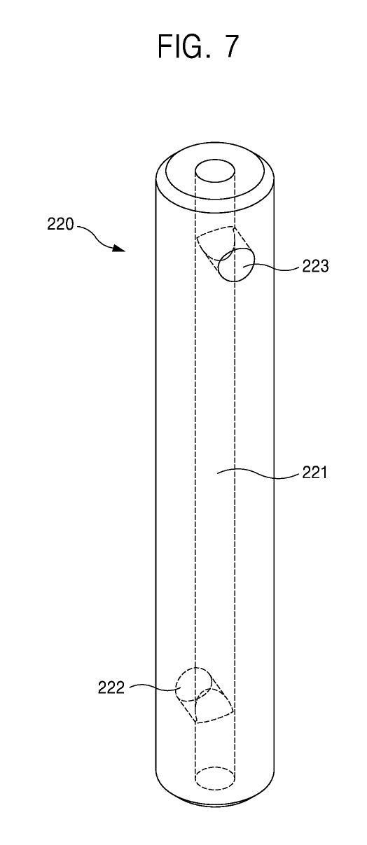

FIG. 7 illustrates a modified example of the power transfer pin.

Unlike the above-described embodiments, a power transfer pin 220 may be applied in a structure of capable of lubricating as illustrated in FIG. 7.

In other words, a lubricant flow hole 221 in which a lubricant flows in a lengthwise direction of the power transfer pin 220 may be provided in the power transfer pin 220.

A lubricant outlet 222 and a lubricant inlet 223 connected to the lubricant flow hole 221, through which the lubricant enters or exits, may be provide in a side wall of the power transfer pin 220.

The lubricant outlet 222 and the lubricant inlet 223 may be arranged in opposite directions along a radial direction of the power transfer pin 220 in areas at opposite ends of the lubricant flow hole 221. Since the present disclosure is not limited thereto, the lubricant outlet 222 and the lubricant inlet 223 may be arranged in the same direction.

When the power transfer pin 220 having the above-described lubrication structure is employed, the power transfer pin 220 may be smoothly rotated, which may be helpful for the movement of equipment.

According to the present embodiment, even when the power transfer pins 220 are employed, since not only the overall height of a device, but also an exterior size thereof may be remarkably reduced, the power transmission device may be easily applied with no restriction to semiconductor or flat display equipment requiring compact parts.

While this inventive concept has been particularly shown and described with reference to preferred embodiments thereof, it will be understood by those of ordinary skill in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

### INDUSTRIAL APPLICABILITY

The power transmission device according to the present inventive concept may be used for various machine tools requiring a rotational motion or a linear motion, industrial machinery, semiconductor or flat display manufacturing facilities, and various kinds of logistics transfer facilities.

1. A power transmission device comprising:
a plurality of power transfer pins mutually corresponding to a tooth shape formed on an outer gear to move the outer gear and having an arrangement structure of a circular shape;
a pin rotation support portion connected to the plurality of power transfer pins and rotatably supporting the plurality of power transfer pins; and
an external rotor motor portion arranged inside in a radial direction of the pin rotation support portion and connected to the pin rotation support portion, and generating rotational power to rotate the pin rotation support portion arranged outside.

2. The power transmission device of claim 1, wherein the external rotor motor portion comprises:
a rotor connected to the pin rotation support portion inside in the radial direction of the pin rotation support portion and rotating with the pin rotation support portion; and
a stator fixedly arranged inside a radial direction of the rotor and rotating the rotor by an applied current.

3. The power transmission device of claim 2, wherein the pin rotation support portion rotatably supports the power transfer pin and comprising a rotor connection body forming one body with the rotor.

4. The power transmission device of claim 3, wherein the rotor connection body is provided in a pair, each rotor connection body arranged at each of opposite end portions of the power transfer pins and connected to the plurality of power transfer pins.

5. The power transmission device of claim 3, wherein the pin rotation support portion further comprises a plurality of pin support bearings arranged at many as the number of the plurality of power transfer pins at equiangular intervals along a circumferential direction of the rotor connection body, and supporting a rotation motion of the plurality of power transfer pins.

6. The power transmission device of claim 5, wherein the pin rotation support portion further comprises a plurality of oil seals provided corresponding to the plurality of pin support bearings one by one and seals a pin insertion support hole in the rotor connection body in which the plurality of power transfer pins are inserted and supported.

7. The power transmission device of claim 2, wherein the external rotor motor portion further comprises a fixed shaft arranged inside the stator.

8. The power transmission device of claim 7, further comprising an absolute position sensor coupled to an end portion of the fixed shaft and detecting absolute positions of the plurality of power transfer pins.

9. The power transmission device of claim 1, further comprising a closing cap coupled to a periphery of the external rotor motor portion and protecting the external rotor motor portion.

10. The power transmission device of claim 1, further comprising a heat sink arranged around the plurality of power transfer pins and radiating heat generated from the external rotor motor portion.

11. The power transmission device of claim 10, further comprising a control circuit provided in the heat sink.

12. The power transmission device of claim 11, wherein an air flow space portion for air flow is formed between the external rotor motor portion and the control circuit in the heat sink.

13. The power transmission device of claim 1, wherein the outer gear is one of a rack, an external gear, and an internal gear.
